(19) United States
(12) Patent Application Publication
(10) Pub. No.: US 2007/0214345 A1
(43) Pub. Date: Sep. 13, 2007

(54) System and method for porting an operating system

(76) Inventor: John Christopher Fleming, Troy, NY (US)

Correspondence Address: Christopher J. Rourk;Godwin Gruber, L.L.P., Suite 1700, 1201 Elm Street, Dallas, TX, 75313-0688, US

(21) Appl. No.: 11/372,881

(22) Filed: Mar. 10, 2006

(51) Int. Cl. G06F 15/177

(52) U.S. Cl. 713/1

(57) ABSTRACT

An apparatus for porting a host operating system and installing an embedded operating system is provided. The apparatus can also be used for storing singular program for use by the host system. The apparatus includes an embedded operating system stored in a storage device. An embedded operating system offload system installs the embedded operating system on a host computer, such as to allow the host computer to run a dedicated application.

### FIELD OF THE INVENTION

The present invention relates generally to operating systems and more particularly to a system and method for porting an operating system of a host computer so as to allow the host computer status and processes to be saved while one or more applications are given operational priority, and to allow the host computer status and processes to be restored after completion of the one or more application. This invention also allows a piece of software to be stored on a computer device. The device makes the software able to be run both normally in a multi tasking environment, and in a dedicated single program environment.

### BACKGROUND OF THE INVENTION

A processor typically requires an operating system to function. For a general purpose processor such as a desktop or laptop computer, the operating system may be the Windows™ operating system, the Unix™ operating system, a version of the Linux operating system, the Apple™ operating system, or numerous other operating systems that coordinate the function of the various components of the general purpose processor and the functioning of software processes on the general purpose processing system.

While operating systems are useful, they suffer from various drawbacks that are well known. One of these drawbacks is the tendency for operating systems to get “bogged down” with the processes they are managing. Even when a user shuts down all processes that are evident, there can be numerous processes running in the “background” that can cause the operating system to allocate resources to processes that are not required at the present time. It is all too common to have to shut down a general purpose computer and re-start it in order to get an application to function properly. Likewise, starting some applications can cause existing applications to experience operational errors, such that data may be lost and the computer must be shut down and re-started.

### SUMMARY OF THE INVENTION

Therefore, a system and method for managing an operating system is required that allows resource-intensive applications to be operated on a general purpose processing system with causing misoperation of the operating system or other existing processes.

In one exemplary embodiment of the present invention, an apparatus for porting a host operating system and installing an embedded operating system is provided. The apparatus includes an embedded operating system stored in a storage device. An embedded operating system offload system installs the embedded operating system on a host computer, such as to allow the host computer to run a dedicated application.

The present invention provides many important technical advantages. One important technical advantage of the present invention is system for porting an operating system status and processes so as to allow a dedicated application to be loaded onto the processor, and to allow the status and processes to be re-loaded upon completion of the dedicated application.

Another advantage provided by the invention is that a single piece of software can be stored on a device (USB, PCI card, etc.) Using this device in place of removable media allows the software to use a dedicated environment, run faster by retrieving program data from a solid state device, and be very difficult to copy.

When the invention is used to store an operating system on a device a new method for running a computer is provided. The host system's resources can remain blank and all operating system overhead (resource use, calculations, etc) can be handled by the device. The device can be optimized for the operating system so that it can not be slowed down. Any third party programs can be spawned and placed on to the host computer's resources.

### BRIEF DESCRIPTION OF THE DRAWINGS

FIG. 1 is a diagram of a system for porting a host operating system and replacing it with an embedded operating system in accordance with an exemplary embodiment of the present invention; and

FIG. 2 is a diagram showing the operation of an apparatus in accordance with an exemplary embodiment of the present invention.

### DETAILED DESCRIPTION OF PREFERRED EMBODIMENTS

In the description which follows, like parts are marked throughout the specification and drawing with the same reference numerals, respectively. The drawing figures may not be to scale and certain components may be shown in generalized or schematic form and identified by commercial designations in the interest of clarity and conciseness.

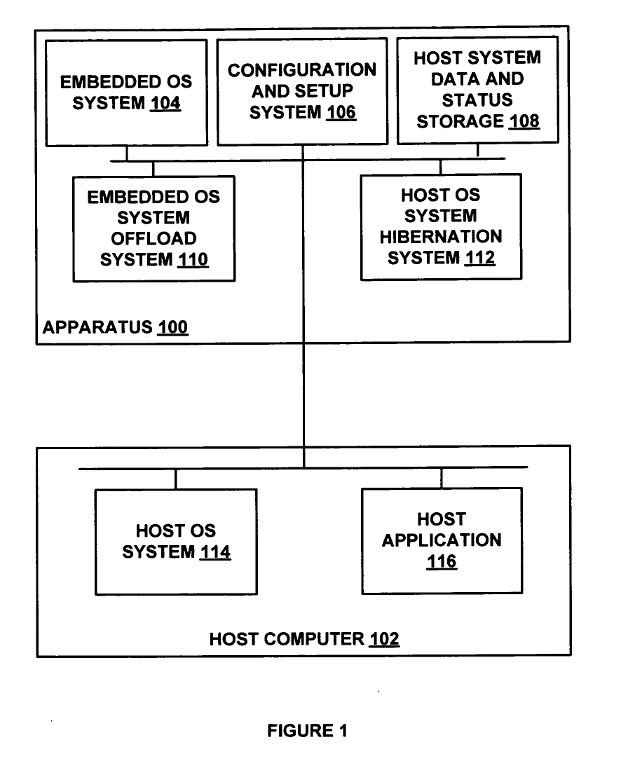

FIG. 1 is a diagram of a system for porting a host operating system and replacing it with an embedded operating system in accordance with an exemplary embodiment of the present invention. Apparatus 100 enables a single program to be called in a host computer's multi-tasking operating system so as to use one hundred percent of the host computer's resources.

In one exemplary embodiment, apparatus 100 can be implemented as a PC add-on card that holds a single board computer (SBC.) The SBC can run a Windows or other suitable embedded operating system (OS). The OS can recognize and interact with its host PC system hardware. Apparatus 100 can further include a simple SBC, such as a processor and memory, on a PC card, a suitable OS stored on flash RAM, power management software to “hibernate” the current OS and load the embedded OS into system RAM, a modified advanced power management (APM) chip on a PC card, and other suitable components.

The first time apparatus 100 is used to install a program such as host application 116, it can precondition the host computer 102, such as by prompting the user to run installation software when the card is detected upon OS startup. The installation software determines the host computer's OS 114 driver library, and any elements the embedded OS 104 needs to mimic in order to properly run on the host computer configuration.

A configuration file can be generated and stored from acquired information about the host system, such as by configuration and setup system 106. The user can then be prompted to select a list of software titles they wish to utilize apparatus 100 with, and to configure options for using it with them.

In one exemplary embodiment, a process such as a software application that the user will run using apparatus 100 is started. The user can then be prompted whether they wish to use apparatus 100. If the user declines to use apparatus 100, the process is run normally in the host system OS. If the user chooses to use apparatus 100, apparatus 100 creates a save state of the current memory and stores it, such as in host system data and status storage 108. Apparatus 100 loads a suitable embedded OS onto the host system, such as with embedded OS system offload system 110, and runs the selected process with it. The process runs until the user terminates it. Upon termination of the process, the host OS and save state data is unloaded, and the host system OS resumes normal operation.

In another exemplary embodiment, if the host system hardware has been changed since the last use of apparatus 100 and the user is attempting to utilize apparatus 100, the user is prompted that the system has changed, and that an updater program will be run. An updater program determines the host system's OS driver library, and any elements the embedded OS needs to mimic in order to properly run on the host computer configuration. A configuration file can be generated and stored from acquired information about the host system.

In another exemplary embodiment, a process such as a software program which has never been run utilizing apparatus 100 can be initiated. The user is notified that the process is new, and must be configured properly to run on the embedded OS. The user can be prompted with a waiting screen while an application specific configuration file is generated.

Widget programs can likewise be stored on apparatus 100 and run through the embedded OS, such as a chat client, voice communication software, or other suitable software. Likewise, widget hardware that would add functionality of apparatus 100 for games or other applications can be provided, such as a separate processor that handles physics calculations. A console game system layout can be provided on apparatus 100 to allow a host system to emulate that console.

Hibernation is the process by which the host computer offloads all information from its RAM to a save file on a storage device, such as host OS system hibernation system 112. A general model can be drawn for the hibernation as follows:

Process housekeeping—Upon receiving a call to hibernate, the current OS must stop all its running processes.

Memory copy—At this stage the OS checks if it has enough memory to save the image, and meet specifications for maximum image size. If necessary, the OS may need to unfreeze the processes and make memory available until the storage space is adequate for fully realizing the memory state, and then try again by restarting the process by rerunning process housekeeping.

Suspend drivers—The OS shuts down any drivers of all hardware.

Save memory state—The OS prepares a directory of pages from the page file and saves it along with the image. This is done in two parts. First, all of the information in the page file that isn't needed to suspend dynamics (i.e., excluding buffer & page caches) are saved in a manner to prevent any impact to the image being made. Then, a copy is made of the remaining pages (kernel & process space) using the memory just saved, and any other free RAM. This copy stores any state variables the OS may need when restarting its processes. Finally, the page directory and its structure are saved for the latter set of pages separately, and the page directory's location in the swap header is stored.

Flush memory—all values and information are removed from the active RAM, and if supported, the host computer powers down. At this point the host computer can run a specific device or process in the empty environment.

In terms of specific operating systems, each one has conceptually similar but physically different implementations for hibernation. Most operating systems that incorporate a hibernate feature use a combination of kernel values/registry keys, and processes. In one exemplary embodiment, Windows™ (such as Windows™ 2000, using an APM power resource chip) can include these processes/registry values/applicable UI, although other suitable processes can also or alternatively be utilized:

Ntdetect.com—detects whether the APM BIOS is present before booting the operating system, determines whether Windows 2000 can use it, and reports the results of detection in the registry.

NtLdr—restarts APM upon resume from hibernate, if APM was active before hibernation.

Ntapm.sys—a driver that hooks the system and the APM BIOS together. It includes certain system operations for dispatch to the APM BIOS, and it polls APM BIOS events and status. Note than when the APM BIOS presents an event (such as suspend or power off), Ntapm.sys catches this, and then issues an NtInitiatePowerAction call, which tells the operating system to respond appropriately. At the end, the Windows™ 2000 power manager calls into the HAL, which calls back into Ntapm.sys, which calls the APM BIOS. In this process, almost all operating system and driver power code is the same between APM and ACPI.

Hal.dll—Windows™ 2000 APM support works only with Halx86, which is the only HAL to have the hooks needed to call into Ntapm.sys. It's also the only HAL relevant to important APM machines in the market.

Apmbatt.sys—emulates a battery unit so the system battery status code can work.

Power Applet—the control panel applet that allows the user to enable or disable APM support on a computer. This is a supported way to turn operating system APM support on or off.

Biosinfo.inf—a file that lists machines on the Autoenable APM list and the Disable APM list, and also lists the BIOS detection sequences used to match them.

Key elements in the registry include Ntdetect Reporting. The data about APM that is discovered by Ntdetect.com is reported in the registry using a Multi-Function Adapter (MFA) entry in the system description of the hardware tree and stored in a suitable location such as HKEY_LOCAL_MACHINE\hardware\description\system\multifunctionadapter. There can be a set of keys there named 0, 1, 2, 3, etc. or other suitable identifiers can be used. Each of the identifiers can have value entries such as component information, configuration data, identifier, and so on. For the key whose identifier entry==“APM,” the “configuration data” entry of that key can contain the data on APM found and reported by Ntdetect.com. If the key is absent, then APM was not found. The contents of this value entry can be reported in sdk\inc\ntapmsdk.h. Running Apmstat.exe -v can dump this structure, for machines where it's relevant. For machines where it's not relevant (such as multiprocessors, not x86, not halx86, ACPI is on, or other suitable machines), Apmstat.exe can report that.

UI Elements—the Control Panel can include a Power applet. If the APM is installed (enabled or disabled), there can be an APM tab in this applet. The APM can be turned on and off by checking the box in this tab, which may be the only recommended and supported way to do so. Turning APM on is an on-the-fly Plug and Play action; turning it off requires a reboot. If the tab is absent, it's an ACPI machine, an APM Disabled machine, the machine simply doesn't have APM, or other APM processes may be used.

Standby on Shutdown Menu—if APM is turned on, there can be a Standby entry under the Shutdown option when the user presses CTRL+ALT+DEL. There can also be a Hibernate entry, which is a separate function. Hibernate can work even if neither APM nor ACPI are present. Standby under APM has the same use as under ACPI.

Battery Status Icon—if the battery display is turned on in the Control Panel Power applet, there can be a Battery Status icon on the system tray, which works about the same as for ACPI. Note that an APM machine can report a single composite battery, regardless of how many are present or what the machine reports. In one exemplary embodiment, Windows™ 2000 uses the unified/composite number, because this is thought to be more reliable on a wide range of APM BIOSes, and is simpler.

Power Button—on most APM machines, the power button, a sleep button, or the like, can suspend the machine (place on standby). Most require the power button to resume, though at least one will come back with a keyboard touch. Windows 2000 APM does not support custom power buttons.

In terms of apparatus 100, hibernation can be started via a small utility process running on the operating system. Once the process determines that the user wishes to utilize the device, it initializes the hibernation process. Apparatus 100 can include an APM device, PCI-PM device, ACPI device, or some other form of system management chip to recognize the system is properly hibernated. Apparatus 100 can then take part in controlling the system once the host OS is offloaded. A system management device or other suitable devices can be used to reload the OS, to implement any other OS or program, or for other suitable purposes. The hardware side of the hibernation can be customized or defined by industry standards. In one exemplary embodiment, specific documentation related to a device's power management can be found on developer networks, and outline all control signals and states involved in the power management process.

Device/System Interaction Description—apparatus 100 can be implemented on different devices or buses on the computer. Three exemplary implementations include a PCI/PCI-express card (for desktop PC hardware), a USB/USB 2.0 device (for both desktops, laptops, and other mobile hardware), and a PCIMA (for laptops, and mobile hardware) Each implementation will need to be able to access, and send calls to the motherboard's APM (Advanced Power Management,) PCI-PM (PCI Power Management,) and/or ACPI (Advanced Configuration Power Interface) from their respective bus's (PCI, PCI-express, USB,) or be able to emulate these devices for specific actions/instances from their respective bus's. They will also require the ability to load a stored element (such as an embedded Windows™ XP OS) on to the system's RAM.

Device Package (USB, PCI card etc,) and Chip Layout Description—the device can be relatively simple for many implementations. For example, a single controller and a storage element can be utilized. On the PCI card package a single Field Programmable Gate Array, burned gate array, application specific integrated circuit or other suitable devices can be used to control the power management, and system interaction functions. An embedded OS such as Windows™ XP can be stored on a flash RAM on the card. The overall simplicity of the device enables a very small layout on the PCI card.

The USB device can be in the form of a dongle. The device can sit in a small enclosure with a USB connection cord attached, and can incorporate an FPGA, burned gate array, ASIC, or other suitable systems that control power management and system interaction functions. Unlike a PCI card, power management may need to be implemented in a different form. The embedded OS can likewise be stored in flash RAM or in other suitable manners.

In one exemplary embodiment, apparatus 100 can be made on a PCI card using a Xilinx™ FPGA and an Intel™ StrataFlash™ embedded memory.

One exemplary embodiment of an embedded OS is Windows XP Embedded, which is a special version of the Windows XP operating system that is specifically designed to run in applications that use an embedded device. Due to the differences between general embedded devices, the OS is customizable in what is known as a run time image, and is developable through a suite of software by Microsoft. For a dedicated environment device, the required run time image can be stored in memory, such as a memory device on the card or other embodiment. Windows XP Embedded can be started via the execution of a hibernation file executed by the device itself, and can read a configuration file stored on the system's existing file system that defines hardware configuration and processes to run. Once running, Windows XP Embedded can run a program (initially chosen by the user before the OS was hibernated) by locating it in file system of the existing OS and executing it. It's operation can be invisible to the user, who only sees the chosen program being run, and no element of the embedded OS, and can contain all available device libraries, daemons, registry files, and processes that a single program would use. The hardware configuration and user options can be loaded into a file during the install process. The installer program can determine hardware, and acquire any of the required drivers, and can then setup a configuration file concerning the hardware, and any user options for XP Embedded to adhere to. If hardware, or option preference is changed, a program must be run to record the new hardware configuration/option choices.

Thus, while Windows XP Embedded is configured to run on embedded devices, it is not configured to replace the OS on a host computer after the OS of the host computer has been ported. To verify proper operation of the Windows XP Embedded on the host computer, the system can be run in a test mode, such as the first time any program is run that utilizes the XP Embedded environment. In this mode the OS can determine the exact registry values, drivers, and processes needed to run the process. A configuration of the OS specific to the process can be stored for future executions.

The actual process or program being run does not need to go through the standard process of piping, where the program information is sent to another through a standard Windows medium. When the user attempts to utilize the card to run a specific program, the program detector utility is given the location of the program in the existing file system. The utility modifies the XP Embedded configuration file, to include the pathway of the program. The XP embedded will execute the program itself using the information stored on the configuration file.

Upon termination of the process or program, the embedded OS is shut down on the host computer, and the host computer's normal OS is resumed by loading its hibernation save state.

Program Dependency Checker Description—to help ensure each program that the device executes will run properly on the embedded OS once it is off-loaded onto the host computer, elements of the process or program can be analyzed. In one exemplary embodiment, the “dependencies” of the program can be fully analyzed, such as by using a software utility to detect if the device is being run with a new program, or a program that it does not possess a proper configuration file for. If no configuration file is found, the utility can analyze the dependencies of the specific program. Once the dependency check is complete, an embedded OS startup configuration file, specific to the process or program, can be generated. The file allows the embedded OS to start with only the dependency requirements that the analyzer utility detected.

Hardware Detector Description—determining the host system hardware can be accomplished by incorporating a program such as a Target Analyzer that is configured to find all attached hardware for an embedded OS. Upon being run, Target Analyzer can generate a file called “devices.pmq.” With the device list, a separate program locates all specific drivers related to the detected hardware. A configuration file consisting of the hardware and drivers is generated for the embedded OS to use when loaded.

Device Driver Description—the driver for the actual device, in any package, incorporates elements of a power management, and storage. Standard drivers such as WDM (Windows Driver Model) or other suitable drivers can be used to handle the PCI/USB interaction for specific device packages.

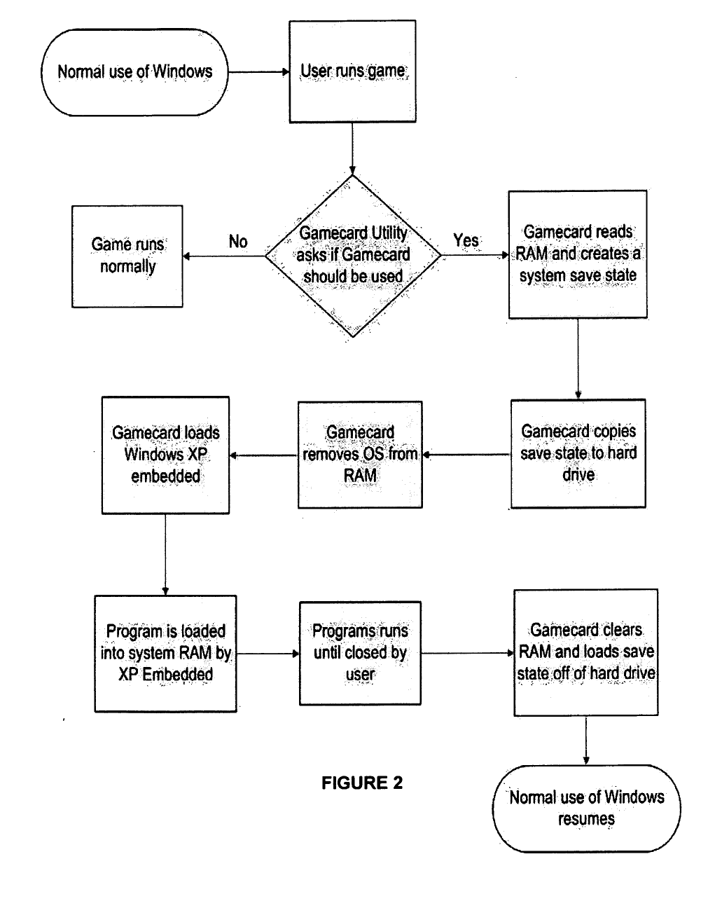

FIG. 2 is a flow chart showing one method of using apparatus 100 in accordance with an exemplary embodiment of the present invention. In the exemplary embodiment of FIG. 2, Windows XP is the exemplary embedded OS, but other suitable embedded OS can also or alternatively be used.

In one exemplary embodiment apparatus 100 is equipped with a piece of software stored on it which may be run in a dedicated environment, or normally as a program run in the host computers operating system. To run the software normally in Windows (i.e. not in the XP Embedded dedicated environment,) the device must supply the program with proper data from its specific bus. In this mode the device will act almost as a hard drive. When the device requires a piece of data it will have the OS pull it from the device, rather than looking to the hard drive, removable media drive, or other storage element. Since the device is typically either on the PCI bus/USB (compared to IDE, SCSI, or SATA channels which are all slower,) and the software's data is stored on solid state memory, the program will be able to run much faster as opposed to being stored on a hard drive. This is because solid state storage is much more quickly accessible than a magnetic/mechanical storage system, and the information accessed will be sent through a faster channel of the computer.

Any version of the apparatus 100 may incorporate connections specific to the software it contains. These connections could be, but are not limited to, USB, Fire Wire, optical connections, RCA connections, audio connections, and other proprietary jack connections. These connections will be incorporated in specific packages designed for a certain company, or piece of software the device is for. Controllers, firmware, and software specific to these devices must be incorporated when adding this feature.

In one exemplary embodiment apparatus 100 is used to execute the host computer's operating system. Apparatus 100 may run the operating system locally on its self, and not use host system resources. It then may allow the operating system to spawn programs that use the host system resources. To accomplish this the device can use a single board computer to handle all elements of the core operating system resources. The device can be optimized for the operating system to insure no slowdown. Any process, that is not part of the core operating system, can be spawned in a manner that uses the device's host system resources. This keeps the main elements of the operating system running optimally no matter how many programs or processes are running.

Although exemplary embodiments of a system and method of the present invention have been described in detail herein, those skilled in the art will also recognize that various substitutions and modifications can be made to the systems and methods without departing from the scope and spirit of the appended claims.

What is claimed is:

1. An apparatus for porting a host operating system and installing an embedded operating system, comprising:
an embedded operating system stored in a storage device; and
an embedded operating system offload system installing the embedded operating system on a host computer.

2. The apparatus of claim 1 further comprising a configuration and setup system storing configuration and setup data for a host application to allow the host application to run using the embedded operating system.

3. The apparatus of claim 1 further comprising a host operating system hibernation system receiving system state data when a host operating system goes into a hibernation mode and restoring the system state data when the host operating system exits the hibernation mode.

4. The apparatus of claim 1 further comprising the ability to store a single program, or operating system, and operate that program, or operating system on the host system.
